(19) United States
(12) Patent Application Publication
(10) Pub. No.: US 2009/0141706 A1
(43) Pub. Date: Jun. 4, 2009

(54) SYSTEM AND METHOD FOR THE AUTOMATIC PROVISIONING OF AN OPENLINE CIRCUIT

(75) Inventors: David CHRISTIE, West Sussex (GB); Anthony WALTERS, Kent (GB); Arvinder KAINTH, London (GB)

Correspondence Address: HOWISON & ARNOTT, L.L.P, P.O. BOX 741715, DALLAS, TX, 75374-1715, US

(73) Assignee: CITRUS INTERNATIONAL LIMITED, SEYCHELLES (GB)

(21) Appl. No.: 12/119,291

(22) Filed: May 12, 2008

(30) Foreign Application Priority Data
Nov. 30, 2007 (GB) GB 0723471.9

(51) Int. Cl. H04L 12/66

(52) U.S. Cl. 370/352

(57) ABSTRACT

A system and method for the automatic provisioning of an openline circuit, specifically for use with a network management system, the system comprising a web GUI (Graphical User Interface) and middleware, wherein the middleware may be synchronized with and instructs a prior art network management system is disclosed. The GUI can be accessed by personnel in an IT department, or by dealers over the Internet via their dealer board using “secure sockets” to be able to make the changes to their openline circuits, including the provisioning of a new openline circuit, the various different inputs being processed by the middleware. The middleware manipulates many SQL (Structured Query Language) databases and is adaptable to work with any network management platform and further is able to provide billing information.

### CROSS-REFERENCE TO RELATED APPLICATIONS

This application claims priority to UK application GB 0723471.9, filed Nov. 30, 2007, entitled “A SYSTEM AND METHOD FOR THE AUTOMATIC PROVISIONING OF AN OPENLINE CIRCUIT,” which is incorporated herein by reference.

### TECHNICAL FIELD

The present invention relates to a system and method for the automatic provisioning of an openline circuit, specifically for use with a network management system.

### BACKGROUND

Dealers who trade on stock exchanges or the like, for example in banks or broking and investment houses need to be able to speak to their clients in an instant in order to obtain their instructions to buy or sell, stock at its current price.

The dealers do so using what is known in the industry as fixed “ring-down” or “openline” circuits. These are dedicated telephone circuits that link two phones together directly, so the caller, known as the “A end” only needs to lift the handset, or push a single button, to reach a counterpart at a remote end, known as “end B”. This type of point to point voice circuit is live at all times (24 hours a day, 7 days a week, 365 days a year) for speed of access. Specifically, these types of circuit do not require any digits to be dialed to be able to talk to the other end of the circuit (the “B end”). An openline circuit is permanently live and on at all times for full two-way voice conversations.

If a dealer did have to dial a series of digits, such as a telephone number in this context, the market that is being traded on would move quicker than the speed at which the trader or broker could speak to their client's counterpart and hence why it is necessary the circuit is permanently connected and “live” at all times—i.e., acting as an “openline”.

The dealers have many clients that they need such openlines to speak to and so use a “Dealer board” otherwise known as a “turret system” which displays the multiple live telephone connections to their counterparts (B end). A dealer will usually have around 10 to 200 of these live “openline” circuits available in front of them, displayed and accessible via their dealer board at any one time. Some of the circuits can even be presented to an open speaker so that the user can hear the remote end talking at all times and the dealer or trader uses normal voice recognition to understand who is talking at any one time. Alternatively, if the circuit is not forwarded to a speaker, then signaling is used where the dealer can simply hit a ring button on their dealer board and the remote end will ring and the particular key (or button) on the phone that the circuit is to be “attached” to will flash for the B end user to pick up. However, even if this method is used, the underlying circuit is live at all times and signaling is just used to raise the dealer's attention.

The terminology used for the openline circuits varies depending upon the type of openline circuit used. Some examples of the terminology used are, “hoot and holler”, “Hoot”, “ARD” (Automatic Ring Down), “MRD” (Manual Ring Down) and “Gen-Gen” (Generator-Generator). The terminology depends on the country and the terminating card used in the dealer board system. Therefore the present invention is not limited to one particular type of openline circuit.

Dealer board systems and/or turret systems are well known in the art and are provided by telecommunications companies such as BT, IPC and Etrali. Software systems have also been developed that allow a dealer to configure their own phone and connections in so far as the Bank's internal network will allow. These systems include products which replaces the Dealer board system with a dealer's PC (personal computer), such as the BT VDIS (Voice and Data Integration Server) product. These products are based on the VoIP (Voice over Internet Protocol) standard. VDIS can link a dealer to their own record of client information and also emulates a dealer board. VDIS can also integrate between the turret system and the users PC, so it does not need to fully replace the turret system. Sprint and CISCO also have their own hotline systems based on VoIP.

There are many problems with these systems, one being that VoIP is simply not secure enough for many banks and broker houses, another is that they only allow configurability and flexibility within the bank's own telecoms network. This also leads to higher levels of complexity and cost. Also, these systems cannot be used to manage a link which is external to the bank's own network.

A Tier 1 service provider, also known as a Local Exchange Carrier (LEC), own the telecommunications infrastructure such as the cables or fiber in the ground that is used to provide the physical connectivity for openline circuits. Examples of Tier 1 providers are BT, COLT and Verizon.

A Tier 2 provider, also known as a Competitive Local Exchange Carrier (CLEC), purchase bandwidth from Tier 1 service providers and then connect this bandwidth to their own private network and to the client's location and then sell telecoms services over this bandwidth. An example of a Tier 2 provider is IPC. Traditionally the Tier 2 service providers purchase the bandwidth and then add their services, and then wrap up the combined price of the bandwidth and the service to the client who then pays the Tier 2 provider for the complete service. In this example, the client is not billed for the bandwidth singularly.

Currently if a dealer needs to connect to a contact within a new client, or a new contact within the organization of an existing client, then currently the dealer has to contact a Tier 1 or Tier 2 service provider, asking for a quotation for a new ring-down circuit with their Tier 1 carrier of choice. They then fill in an order form either manually or on-line, submitting the order to their own internal telecommunications administration team, who acknowledge the expense, (rather than agree to it) and they then pass the order to an engineering division, or IT department. The IT department then have to contact the chosen service provider, as well as the IT department of the dealer's counterpart (B end) and request the provision of the new ring-down circuit. These processes are currently all done manually, with the e-mailing or faxing of paper copies of order forms and quotation information. The final part, i.e., the actual circuit provisioning process can take between 4 hours and 60 days depending on network bandwidth availability. Once the circuit is confirmed as configured and operational, both the A End and B end will test the circuit is working and operational and sign off the circuit as fully operational and in service. Then the ordering dealer (A end) and so his company, will receive a monthly invoice of the agreed amount from the chosen service provider. An example of a system of the prior art, including the relationship between Tier 1 and Tier 2 service providers, is described in more detail with reference to FIG. 1 below.

In the trading world, a delay of even an hour can mean a huge market deal opportunity for a new client can be potentially lost. The time taken to set up, or “provision” a new ring-down circuit, as well as the complex process involved in setting it up, is therefore extremely important to a trader.

Currently in the UK there are approximately 100,000 of ring-down circuits for various trading brokers and banks split over various Tier 1 carriers such as COLT, Verizon and/or BT, managed by a number of different Tier 2 service providers. Both Tier 1 and Tier 2 carriers can provide point to point openline voice services, but more recently Tier 2 carriers have been doing more so.

A broker house or bank will also themselves spread their circuits over more than one carrier in order to balance risk and in case of an emergency or disaster which effects only one carrier in particular. This adds to the management problem because when a trader requests a new circuit to an end B that has already another connection within the same broker house, it is beneficial to place that new connection with another carrier in order to minimize risk. It is virtually impossible at present for IT departments with many circuits across more than one carrier to physically picture where all their circuits are going in order to quickly load balance and make effective disaster recovery plans.

The ability of a company to make an adequate disaster recovery plan is all important since the outcome of the Sarbanes-Oxley Act of 2002. The Sarbanes-Oxley (Sox) Act is a piece of US legislation which affects US law concerning accounting and investor protection practices and “MiFID” (The Markets in Financial Instruments Directive) is the corresponding European legislation. Both practices centre on managing risk within a company and that a company's internal controls are being effective.

The present invention therefore seeks to overcome, or at least reduce some of the above-mentioned problems of the prior art.

### SUMMARY

In one aspect thereof, the invention provides a system for the automatic provisioning of an openline of circuit using a network management system, the openline having a first end and a second end, the system comprising a first input, wherein the first input receives a provisioning request about either the first end or the second end of an openline circuit, a first output, a processor, wherein the processor is coupled to the first input and the first output and wherein the processor processes the provisioning request and instructs a network management system, via the first output, to provision an openline circuit.

One advantage is that the network management system may be accessed remotely by anyone at any location and the provisioning of the circuit is electronic data based not paper based. Another advantage is that it allows for user self provisioning, deletion and relocation of the service, rather than a user being dependant on a carrier to carry out the provisioning task.

Preferably wherein the first input may receive a provisioning request about the first end and the second of an openline circuit and the processor processes both of the provisioning requests and instructs a network management system, via the output, to provision an openline circuit and further preferably wherein the processor stores the provisioning requests in a database.

One advantage is that the two requests can come from two different parties at two different times and the data about each end of the circuit can then be stored before the end to end path is provisioned.

Preferably wherein the first input is a Graphical User Interface (GUI) and further preferably wherein the GUI is accessible over the Internet using secure sockets.

One advantage being that the system is easily accessible by anyone anywhere securely without the use of any extra specialist equipment or knowledge, which also allows the tasks to be carried out by non engineering personnel such as traders or administrators.

Preferably wherein the database further comprises information about the first end or the second end and further preferably wherein the information is displayed via a second output to a GUI.

One advantage is that a user may view the details of their circuits using the system.

According to a second aspect, the invention provides a system for the automatic provisioning of an openline circuit using a network management system, the openline circuit having a first end and a second end, the system comprising an input, which accepts an identifier from a user, a database, wherein the database stores a piece of information about an openline circuit, or a first end, or a second end and the user, an output, a processor, wherein the processor is coupled to the input, the output and the database; and wherein the processor compares the identifier with the user information stored in the database and outputs at least one piece of information about the openline circuit, or the first end, or the second end.

One advantage is that the user can only view information about circuits which they have the authority to view and not circuits of another customer.

According to a third aspect, the invention provides a system for the automatic provisioning of an openline circuit using a network management system, the openline circuit having a first end and a second end, the system comprising an input, wherein the input can receive a provisioning request about an openline circuit, a database, wherein the database stores a piece of data about an openline circuit, or a first end, or a second end, an output, a processor, wherein the processor is coupled to the input, the output and the database and wherein the processor, based on the provisioning request, outputs the piece of information about the openline circuit, or the first end, or the second end.

One advantage is that the system can use the provisioning request and the information stored in the database to inform the user that they need to load balance their circuits across different carriers as required by risk management legislation. This is not only from a location perspective, but also from an individual user perspective. The system can tell the user via the GUI if an individual user is already on the chosen E1/T1 circuit and so allow full load balancing and thus required conformance with Sox and MiFiD. The system can also give a user an indication of the status of the connected carrier circuits.

Preferably that in accordance with the first aspect, the second and the third aspect, wherein the processor is kept synchronized with the network management system. Further preferably that the system is mirrored.

One advantage is that the data provided by the system to the user is kept up to date with that which is happening in the network and the also system is not vulnerable to interruptions due to problems with hardware or software malfunction.

According to a fourth aspect, the invention provides a method for the automatic provisioning of an openline circuit using a network management system, the openline circuit having a first end and a second end, the method comprising receiving a provisioning request about either the first end or the second end of an openline circuit, processing the provisioning request and instructing a network management system to provision an openline circuit.

Preferably further comprising receiving a provisioning request about the first end and the second of an openline circuit, processing both of the provisioning requests and instructing a network management system to provision an openline circuit. Further preferably storing the provisioning request, or requests in a database.

Preferably wherein a user inputs the provisioning request using a GUI and that the GUI can be accessed by the user over the Internet using secure sockets.

According to a fifth aspect, the invention provides a method for the automatic provisioning of an openline circuit using a network management system, the openline circuit having a first end and a second end, the method comprising accepting an identifier from a user, storing a piece of data about an openline circuit, or a first end, or a second end and the user, comparing the identifier with information stored about the user, outputting the piece of information about the openline circuit, or the first end, or the second end.

According to a sixth aspect, the invention provides a method for the automatic provisioning of an openline circuit using a network management system, the openline circuit having a first end and a second end, the method comprising receiving a provisioning request about an openline circuit, storing at least one piece of information about an openline circuit, or a first end, or a second end, comparing the provisioning request to the piece of data about the openline circuit, or at least one first end, or at least on second end, outputting the piece of information about the openline circuit, or the first end, or the second end.

### BRIEF DESCRIPTION OF THE DRAWINGS

For a more complete understanding, reference is now made to the following description taken in conjunction with the accompanying Drawings in which:

FIG. 1 shows an architecture diagram showing a provisioning system according to the prior art;

FIG. 2 shows an architecture diagram of a provisioning system, according to one embodiment of the present invention;

FIG. 3 shows a flow diagram illustrating a first part of a process of creating a new circuit, according to one embodiment of the present invention; and

FIG. 4 shows a flow diagram illustrating a second part of a process of creating a new circuit, according to one embodiment of the present invention.

### DETAILED DESCRIPTION

Referring now to the drawings, wherein like reference numbers are used herein to designate like elements throughout, the various views and embodiments of a system and method for the automatic provisioning of an openline circuit are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

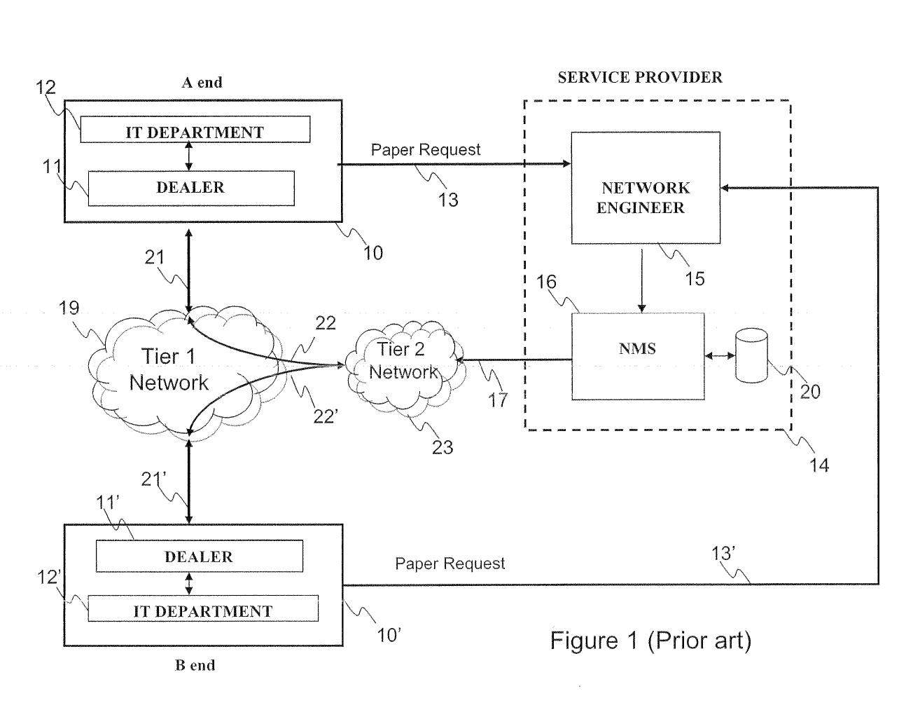

FIG. 1 is an architecture diagram showing a provisioning system according to the prior art. There is shown a bank or broking and investment house 10, which is marked “A end”, wherein its dealers 11 use a dealer board system (not shown). The bank 10 also has an IT department 12. The dealer board system used within the bank 10 is connected across a Tier 1 telecoms network 19 via a large “pipe” 21 and a Tier 2 network 23, via a “smaller” pipe 22 (explained in more details below) to another bank 10′ which has a corresponding IT department 12′ and dealer 11′.

The end to end connection 21, 22, and 21′, 22′ uses network equipment provided by a Tier 2 service provider 14 as well as equipment provided by a Tier 1 carrier (not shown), as well as dealer board equipment located in the A end and B end which is operated by the banks 10, 10′.

Working within the Tier 2 service provider 14 are network engineers 15 who control and maintain a network management system 16. The network management system 16 connects to the Tier 2 telecoms network 23 via a two-way telecommunications link 17.

The pipes 21, 22, 21′ and 22′, which connect the openline circuit across the telecoms networks 19, 23 are of various sizes and have standard names, which are defined by the IEEE and are well known in the art, as shown as follows:

TABLE 1
IEEE circuits

| | |
|---|---|
| UK | US |

| | | | |
|---|---|---|---|
| STM-1 | 155 Mbps | OC3 | 155 Mbps |
| DS3 | 45 Mbps | E3 | 34 Mbps |
| E1 | 2 Mbps | T1 | 1.5 Mbps |
| DS0 | 64 kbps | DS0 | 56-64 kbps |

In an E1 there are 32 DS0 circuits, but only 30 are usable for service. There are 2 DS3 circuits in an STM-1 circuit and there are 63 E1 circuits in an STM-1. Tier 2 providers generally connect to Tier 1 carriers using DS3/E3 and above and Tier 1 carriers will provide E1/T1 to the end clients (A ends or B ends).

The Dealer board or turret systems comprise a cross connect switch (a term well known in the art) that connects to the Tier 1 network 19 using E1/T1 circuits. Some manufacturers are working on an Ethernet interface also for external connectivity. The dealer board switch itself can terminate hundreds of E1/T1 circuits which connect directly to the outside world. The Tier 2 service provider presents 30 voice circuits over the E1 circuit which can be presented on multiple Dealer board phones on dealer's desks via network management software that is proprietary to the dealer board switch. Most organizations also connect a few E1 circuits from their own PABX (Private Automatic Branch Exchange) equipment to the Dealer board system so that the traders can have an internal extension number as well for internal calls. The PABX also connects to the public PSTN (Public Switched Telephony Network) to provide external dialed digits calls. This connectivity is well known in the art.

Currently if a dealer 11 needs to connect to a new dealer 11′ within the other bank 10′, or a new contact (11′) within the organization of an existing client (or bank 10′), then currently the dealer 11 has to contact the Tier 2 service provider 14, asking for a quotation for a new ring-down circuit within existing “pipes” 21 and 22, also with an indication of which Tier 1 carrier they wish to use to provide the connection 21, 22 across the Tier 1 network 19. As explained previously, they then fill in an order form either manually or on-line, submitting the order to their own account team, who acknowledge the expense, and they then pass the order to the engineering division, or IT department 12. The IT department 12 then have to contact the Tier 2 service provider 14, as well as the IT department 12′ of the counterpart dealer 11′ marked as (end B) and request the provision of the new openline circuit.

The actual openline circuit within the pipes 21, 22 and 21′, 22′ is then provisioned (created, moved or deleted) by the network engineer 15 using network management software 16 via the telecommunications link 17. The network management system 16 is normally a HP Server or equivalent running Windows Server or Unix with propriety software which operate the actual network devices in the Tier 2 telecoms network 23. Network devices used in the Tier 1 and Tier 2 telecoms networks 19, 23 to provide the openline circuits would usually be equipment manufactured by Sycamore Networks, Newbridge Networks, Cisco or Nortel Networks, for example.

The previously described processes are currently all performed manually; with the faxing or emailing of paper copies of order forms and quotation information (see link 13 and 13′). The final part, i.e., the actual circuit provisioning process can take between 4 hours and 60 days depending on network bandwidth availability and on how busy the network engineer 15 is. Once the openline circuit is operational, then the ordering dealer 11 (A end) and so his bank 10, will receive a monthly invoice of the agreed amount from the Tier 2 service provider 14.

As mentioned previously, Tier 1 carriers can also provide openline circuits, but now-a-days this is becoming less usual.

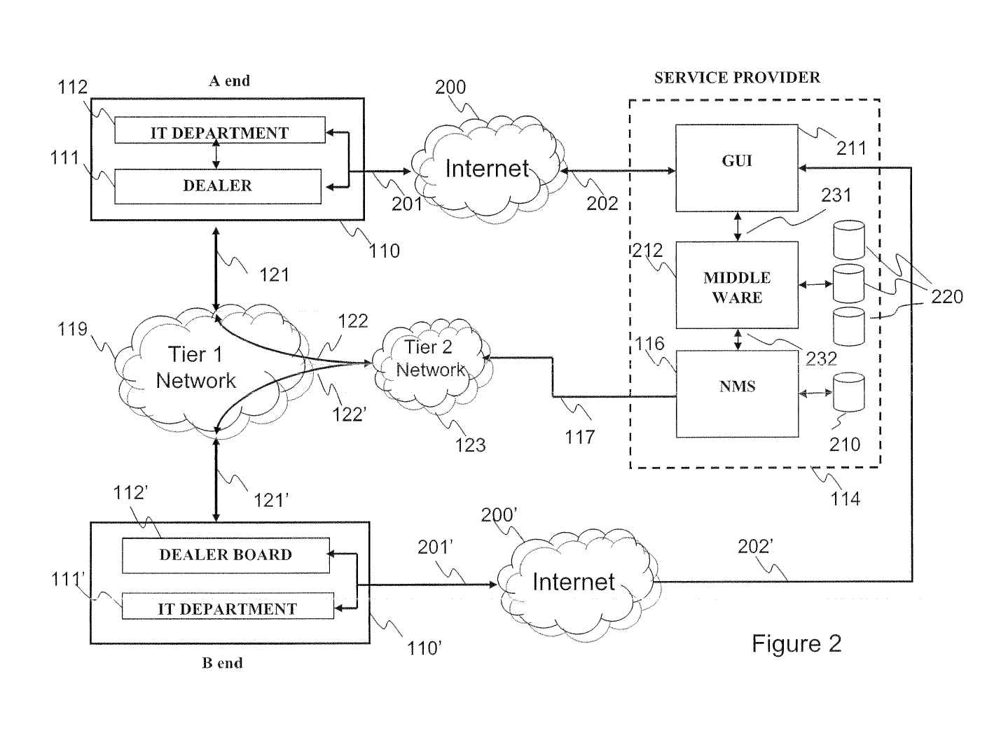

In a brief overview of one embodiment of the present invention, there is shown in FIG. 2 an architecture diagram of a provisioning system. The system comprising a web GUI (Graphical User Interface) 211 coupled to middleware 212 via two-way link 231. Also shown is a network management system 116, which may be the same network management system 116 as described with reference to FIG. 1. The network management system 116 is coupled to the middleware 212 via two-way link 232.

As in FIG. 1 described previously, there are banks or broking and investment houses 110, with dealers 111 who use a dealer board system (not shown). The bank 110 also has an IT department 112. There is also shown a corresponding “B end” bank 110′, with a corresponding IT department 111′ and dealer 112′

Also as explained previously, the dealer phones within the banks 110, 110′ are connected to network equipment within the bank (not shown), such as a PABX. The network equipment is then connected to a Tier 1 telecoms network 119 via a large “pipe” 121, 121′ for example an E1. There is also shown a Tier 2 telecoms network 123. The end to end connection from A end to B end routes across pipes 121 and 122, and then back across 122′ and 121′, as shown in FIG. 2 (and also described previously with reference to FIG. 1). The network management system 116 connects to the Tier 2 telecoms network 123 via a two-way telecommunications link 117 and is managed by a Tier 2 service provider 114, as before.

The web GUI 211 is used by either the IT department 111, 111′ of the bank or broker and investment house 110 or by the dealer 112, 112′ from their desk, or from home for example, to be able to provision their own circuits via a PC using connections 201, 202 and 201′, 202′ across a telecommunications network such as the Internet 200, 200′. Using this GUI, all IT personnel can provision the openline circuit themselves without the need to put in a paper order with the Tier 2 service provider 114. A person skilled in the art will appreciate that the middleware 212 also connects to the network management system operating the PABX equipment in the A end and B end banks 110, 110′ in order to fully provision the openline circuit end to end.

With reference to the A end, the GUI 211 can be accessed by personnel in an IT department 112, or by dealers 111 over the Internet 200 via connections 112 and 202 using “secure sockets” to be able to access their accounts and then make the changes and requests that are processed by the middleware 212 to facilitate the request. This means that order processing or account management paper processes need not be used. “Secure sockets” is a mechanism used and known in the art to enable secure connections 112, 202 to the Internet 200. The B end bank 110′ can also connect into the system in the same way.

The middleware 212 provides the translation between the “front end” GUI 211 and the “back end” network management system 116 that actually makes the changes to the telecoms network 119. The middleware 212 manipulates many SQL (Structured Query Language) databases 220 (see below for further details). The middleware 212 is adaptable to work with any network management platform 116 (including any used in the A end or B end for provisioning the dealer board switch) and is able to provide specific billing information concerning the number of timeslots used or the number of times change requests are made for example.

The middleware's multiple SQL databases are described following:
1. A Path database; which is updated/amended when users have inputted both the A end and B end physical connection information. Each record in the path database contains the following fields:
   Path Reference
   Creation Date
   Local (A end) Termination
      Caller ID
      Company ID
      Location ID
      Envision Node
      Envision Port
      Timeslot
   Alternate Local
      Caller ID
      Company ID
      Location ID
      Envision Node
      Envision Port
      Timeslot
   Remote (B end) Termination
      Caller ID
      Company ID
      Location ID
      Envision Node
      Envision Port
      Timeslot
   Alternate Remote
      Caller ID
      Company ID
      Location ID
      Envision Port
      Timeslot
   Status

As can be seen from the record, there are two sets of records for local and remote end (A and B end) terminations of the circuits, as well as another set of records for alternative, disaster recovery, circuits which are set up at the same time. The terms “Port” and “Node” are used and are known in the art to describe the actually physical connectivity between pieces of telecoms equipment. The field “Status” is used to describe whether a circuit is active, inactive, or in an alarm condition with regards to physical connectivity or whether there is an error on the actual circuit.
2. A Caller Database; which is a database of information about all A end and B end locations on the system, which is accessible by anyone who is securely logged in. It also contains fields for an A end or B end disaster recovery locations (after Sarbanes Oxley, every trader has a location to which they must be able to move to and carry on working in case of major emergency such as 9/11). Each record in the caller database contains the following fields:
   Company ID
   Location ID
   Caller ID
   Surname
   First Name
   Desk Location or Number
   Telephone Number
   Email Address
3. A Connection Database: 30 new records are added to the port database every time a new A end or B end connection is inputted and each record in the connection database comprises the following fields:
   Company ID
   Location ID
   Envision Port
   Line File Information
   Local Carrier
   Carrier Reference
   Customer Port Location
   Timeslot
   Timeslots Status (Free/Used/Reserved)
   Creation date

The field “Line File information” is used to contain information about the dealers dealer board phone and is term used in the art. The filed “Local Carrier” is a field containing information the name of the carrier used, whilst “Carrier reference” contains a circuit code pertaining to that carrier. The customer port location field contains information about the physical port on the customer's telecoms equipment that the circuit is connected to.
4. A company database; companies are added to this database every time a new customer account is created and it is used for billing purposes and to store and set up the user login information (credentials). Each record in the company database comprises the following fields:
   Company ID
   Company Name
   Contact Information
   Billing Address
   Billing Information
   User Login Information (Login name and password(s))
5. Location database: location information, including disaster recovery location information, is added by companies into the company database. Each record in the location database comprises the following fields:
   Company ID
   Location ID
   Address

The Path database is directly linked and kept synchronized to the Network Management System (Envision Plus) Database, by the middleware 212, as described in further details following.

The network management system 116 is a piece of proprietary software (loaded onto a platform provided by HP) that in this embodiment is a Sycamore Networks network management system called “Envision Plus” and so is used under license. The middleware 21 can be adapted to be used with any Network Management system 116 to allow full hardware flexibility.

The GUI 211, middleware 212 and network management systems 116 are all implemented using HP servers such as the HP “Proliant” series. Although each of the GUI 211, middleware 212 and network management systems 116 may be constructed with have different memory/hard disk configurations.

The GUI 211 and middleware 212 are protected by various firewall layers and encryption techniques to protect data and all backups will be held in alternate locations to the main databases 210, 220.

All databases 210, 220 as well as carrier connections 121, 117 are mirrored in order to be able to recover after an emergency or disaster.

New customer accounts are set up by personnel in the IT department 112, or by the dealer 112 and this would include filling in the fields in the customer database, as well as inputting existing A end and B end information (into the caller database) as well as the initiation of an automated credit check.

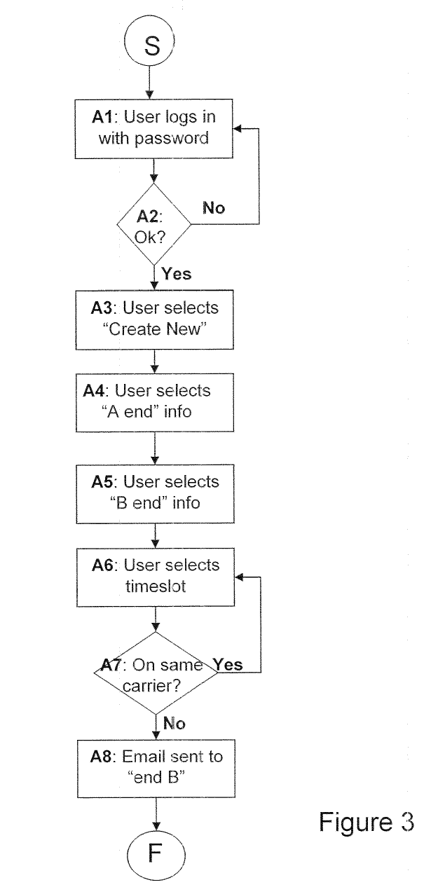

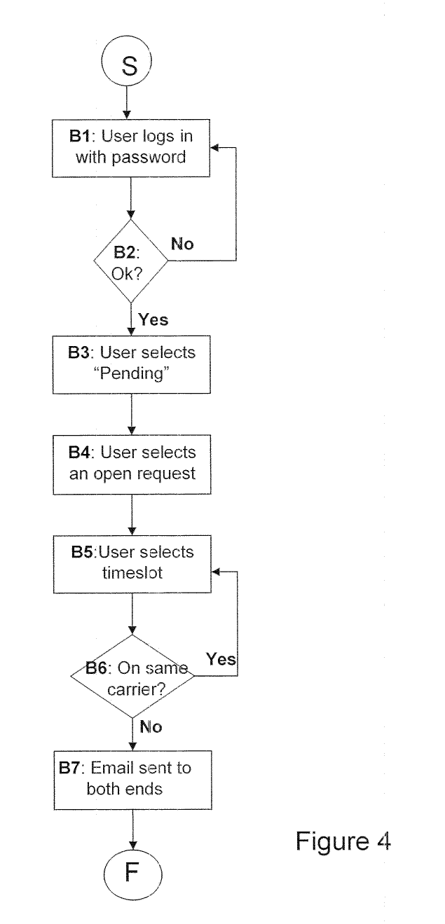

The provisioning processes will now be described in further detail with reference to FIGS. 3 and 4 below.

FIG. 3 shows a flow diagram illustrating a first part of a process of creating a new circuit, according to one embodiment of the present invention.

When a user needs to make a new connection, the following steps are carried out; the process starting at the point marked “S.”
A1: In this step, a user (dealer or person in an IT department) connects the GUI via a secure website known in the art as (portal) across an existing telecommunication's network, such as the Internet. One of the first screens that is displayed is a login screen. Via this portal the A end will log into their existing account, using pre-arranged login and personal details which were inputted by the user when they first set-up their own account.
A2: The user's login details are verified by comparison to the relevant fields in the customer database. If they are accepted, the process flows follows the YES path to step A3, if not, the user follows the NO path back to step 1.
A3: The following options are then displayed to the user on the “main menu” screen:
   1. Create connection
   2. Delete Connection
   3. Amend Connection
   4. Disaster Recovery
   5. Admin
   6. Pending

The user would then select “Create New Connection”. Via pull down menu, the GUI displays all the addresses of traders at the A end and their disaster recovery location, or the current trader's location and their disaster recovery location, which is essentially a display of the relevant records in the caller database.

Also displayed are how many connections he has already paid for, how many he is using and how many he has left. Also displayed is the carrier information for each connection, as explained previously most large banks use more then one. This is essentially a display of a specific subset of the relevant records in the connections database.

This enables the dealer or IT person to use either link which is less used, or a link which allows the connections to the same B end to be spread, as explained following:
A4: The user selects the A-end information from a drop down menu (a display of the caller database).
A5: The user selects an E1, then a DS-0, then a particular timeslot as displayed on his screen (from the connections database) that the new ring down type of circuit is to be provisioned in. Load balancing information is then displayed which is specific to the user. If the particular dealer is already configured on the E1 circuit then this is identified so the IT person or dealer may choose another E1 circuit to configure the circuit on, if there is one available. This part of the process will continue until the IT person or dealer finds an E1 circuit that the dealer is not configured on, or until the user over rides the system and goes ahead and configures the circuit anyway. This would be despite the fact that the dealer is already present on the selected E1 circuit and this would be the case if no other options were available.
A6: The user then inputs the Trader's name and location information of the B end connection, which he selects from a list of possible clients and trader details (from the company and caller databases).
A7: A check is then made to see if there is already a connection to this B end from within the broker house or bank. If so, a suggestion is made to the user that another carrier should be used. Via the YES link, the step A6 is repeated. If no, the process moves onto step A8.
A8: Once the user has settled on a timeslot and inputted the B end information, then an email is sent to all the personnel working in the B end, and/or to the B end trader stating “A request to connect from “A ends” has been made, please log into system and accept/reject request.” The email must be within SOX and MiFID rules i.e. no mails can be sent which contain user information, just a request to log into the GUI.

This part of the process flow then finishes at the point marked “F”.

FIG. 4 shows a flow diagram illustrating a second part of a process of creating a new circuit, according to one embodiment of the present invention. The process starts at the point marked “S” and is instigated when the B end receives the email concerning the A end request.
B1: The B end then logs into their secure portal with their log in credentials.
B2: The user's login credentials are verified as described in step A2 previously. If the credentials are accepted, the process flow moves to step B3 via the YES path. If not, the user is returned to step B1 as before.
B3: The same screen is now displayed as in step A4 described previously. This time, in stead of choosing to create a new connection by selecting “Option 1”, the user will see that option 6. “Pending” has a “1” or a flag next to it, suggesting an email request has been received. The user then selects option 6. “Pending”.
B4: The user then accepts or rejects the open request.
B5: If the user accepts the request, then the B end user then selects an, E1 then a DS-0, then a particular timeslot as displayed on his screen (from the connections database) that the new ring down circuit is to be provisioned in at his end. At this stage per user load balancing information is again displayed if a dealer is already configured on the selected circuit and this information is displayed until the system is over ridden by the person configuring the circuit, as described above.
B6: A check is then made to see if there is already a connection to the A end from within the broker house or bank using the same carrier. If so, a suggestion is made to the user that another carrier should be used. Via the YES link, the step B6 is repeated. If no, the process moves onto step B7.

Once this is done, a new end to end connection (path) based on the inputted A end and B end timeslot information (via steps A 6 and B5), is created as a new record in the path database. The following fields of the new record within path database are then synchronized with network management system and thus the new end to end connection is made across the telecoms network:
Path reference
Local (A end)
   Envision Node
   Envision Port
   Timeslot
Alternative Local
   Envision Node
   Envision Port
   Timeslot
Remote (B end)
   Envision Node
   Envision Port
   Timeslot
Alternative Remote
   Envision Node
   Envision Port
   Timeslot
B7: An email is then sent to both the A end user and the B end user which contains a network ID code for the new connection (for record and billing purposes). The email also requests that both ends check the connection and reports back to the service provider if any problems are found.

With reference to the “main menu” screen above Option 2 may be chosen if a user wishes to delete a connection—again an email is sent to the B end notifying them of the deletion. However, a single engineer cannot delete the path alone due to regulatory requirements. Once an engineer chooses which DS0 to delete, an email is then automatically sent to his manager who also then has to log into the system to authorize the deletion. Once he does this, then the system deletes the path and an email is generated to A and B ends notifying them of the deletion.

Option 3 may be chosen if a user wishes to amend a single connection, or many connections at the same time. Or example, if all the connections on one pipe (E1) need to be moved together, then they can be loaded into an online “shopping basket” and simultaneously moved to another carrier or pipe if required. In this case, no email is sent to the B end unless an amendment is made to the B end details.

Option 4 is where the service provider can choose to configure the GUI and middleware with their own mirroring and disaster recovery information in order to protect the automatic provisioning system in case of an emergency.

Option 5 is chosen when a user within the service provider needs to set up or amend billing and/or account details for new or existing customers.

According to the present embodiment of the invention the middleware is only synchronized with the network management system when a transaction needs to occur. The same is true in reverse; if there is a change state within the network management system then the network management system will update the middleware. Further if a user is connected and logged into the GUI and that state change affects what they are looking at, then they will see the update reflected on their screen. This would be something like “loss of circuit synchronization”, for example, which is a condition well known in the art.

Alternatively, the middleware could poll the network management system at regular intervals, such as every 5 seconds in order to remain synchronized.

Essentially the middleware 212 of the present invention replaces the human interface of a network engineer making system changes as in the prior art provisioning and deletion process (described with reference to FIG. 1) but is able to provide much more tailored functionality to a remote user, as described previously. The system also stores an audit trail of actions to meet all regulatory requirements.

The present invention provides the ability to allow the client to put one circuit into their primary site and a second into their secondary site and they can move all of their circuits at any given time either as a single circuit (DS0) or multiples using their online “shopping basket” which will allow the clients to move all their connections under their own control and provide an audit trial for any regulatory body.

Therefore, using the present invention, an end to end connection from a dealer board to a counterpart in a client location can be made in minutes rather than hours, and from any location in the world via the Internet and by any authorized person.

It will be appreciated that although only one particular embodiment of the invention has been described in detail, various modifications and improvements can be made by a person skilled in the art without departing from the scope of the present invention.

It will be appreciated by those skilled in the art having the benefit of this disclosure that this system and method for the automatic provisioning of an openline circuit provides a GUI and middleware, wherein the middleware may be synchronized with and instructs a network management system. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A system for the automatic provisioning of an openline circuit using a network management system, the openline circuit having a first end and a second end, the system comprising:
an input, wherein the input is configured to receive a provisioning request corresponding to at least one of the first end or the second end of the openline circuit;
a first output;
a processor coupled to the input and the first output; and wherein the processor is configured to process the provisioning request and instruct the network management system, via the first output, to provision the openline circuit.

2. The system according to claim 1, further comprising a database configured to store the provisioning request.

3. The system according to claim 2, wherein the input is a Graphical User Interface (GUI).

4. The system according to claim 3, wherein the GUI is configured to be accessible over a public network using secure sockets.

5. The system according to claim 2, wherein the database further comprises information corresponding to the first end or the second end.

6. The system according to claim 5, wherein the information is displayed via a second output to a GUI.

7. The system according to claim 1, wherein the provisioning request includes a first provisioning request corresponding to the first end and a second provisioning request corresponding to the second end of the openline circuit and wherein the input receives the first provisioning request and the second provisioning request and wherein the processor is configured to process the first provisioning request and the second provisioning request and instruct a network management system, via the first output, to provision the openline circuit.

8. The system according to claim 7, further comprising a database configured to store at least one of the first provisioning request and the second provisioning request.

9. The system according to claim 8, wherein the input is a Graphical User Interface (GUI).

10. The system according to claim 9, wherein the GUI is configured to be accessible over a public network using secure sockets.

11. The system according to claim 8, wherein the database further comprises information corresponding to the first end or the second end.

12. The system according to claim 11, wherein the information is displayed via a second output to a GUI.

13. The system according to claim 1, wherein the processor is configured to maintain synchronization with the network management system.

14. The system according to claim 1, wherein the system is mirrored.

15. A system for the automatic provisioning of an openline circuit using a network management system, the openline circuit having a first end and a second end, the system comprising:
an input, wherein the input is configured to accept an identifier from a user;
a database, wherein the database stores information corresponding to the user and at least one of the openline circuit, the first end, or the second end;
an output; and
a processor coupled to the input, the output and the database, and wherein the processor is configured to compare the identifier with the stored user information and output a portion of the stored information corresponding to the openline circuit, the first end, or the second end.

16. The system according to claim 15, wherein at least one of the input or output is a Graphical User Interface (GUI).

17. The system according to claim 16, wherein the GUI is configured to be accessed over a public network by secure sockets.

18. The system according to claim 15, wherein the processor is configured to maintain synchronization with the network management system.

19. The system according to claim 15, wherein the system is mirrored.

20. A system for the automatic provisioning of an openline circuit using a network management system, the openline circuit having a first end and a second end, the system comprising:
an input, wherein the input is configured to receive a provisioning request corresponding to the openline circuit;
a database, wherein the database is configured to store data corresponding to at least one of the openline circuit, the first end, and the second end;
an output;
a processor coupled to the input, the output and the database, and wherein the processor is adapted to use the provisioning request to output a portion of the data corresponding to the openline circuit, the first end, or the second end.

21. The system according to claim 20, wherein at least one of the input or the output is a Graphical User Interface (GUI).

22. The system according to either claim 21, wherein the GUI is configured to be accessed over a public network using secure sockets.

23. The system according to claim 20, wherein the processor is configured to maintain synchronization with the network management system.

24. The system according to claim 20, wherein the system is mirrored.

25. A method for the automatic provisioning of an openline circuit using a network management system, the openline circuit having a first end and a second end, the method comprising:
receiving a provisioning request corresponding to at least one of the first end or the second end of the openline circuit;
processing the provisioning request; and
instructing the network management system to provision the openline circuit.

26. The method according to claim 25, wherein receiving the provisioning request comprises:
receiving a first provisioning request corresponding to the first end and a second provisioning request corresponding to the second end of the openline circuit.

27. The method according to claim 26, further comprising storing at least one of the first provisioning request and the second provisioning request in a database.

28. The method according to claim 25 further comprising storing the provisioning request in a database.

29. The method according to claim 25, further comprising using a Graphical User Interface (GUI) to input the provisioning request.

30. The method according to claim 29, wherein the GUI is configured to be accessed by the user over a public network using secure sockets.

31. The method according to claim 25, further comprising maintaining synchronization with the network management system.

32. A method for the automatic provisioning of an openline circuit using a network management system, the openline circuit having a first end and a second end, the method comprising:
accepting an identifier from a user;
storing data corresponding to the user and at least one of the openline circuit, the first end, and the second end;
comparing the identifier with the stored user data; and
outputting a portion of the stored data corresponding to the openline circuit, the first end, or the second end.

33. The method according to claim 32, further comprising maintaining synchronization with the network management system.

34. A method for the automatic provisioning of an openline circuit using a network management system, the openline circuit having a first end and a second end, the method comprising:
receiving a provisioning request corresponding to the openline circuit;
storing information corresponding to at least one of the openline circuit, the first end, and the second end;
comparing the provisioning request to the stored information corresponding to the openline circuit, the first end, or the second end; and
outputting a portion of the stored information corresponding to the openline circuit, the first end, or the second end.

35. The method according to claim 34, further comprising using a Graphical User Interface (GUI) to input at least one of the identifier or the provisioning request.

36. The method according to claim 35, wherein the GUI is configured to be accessed by a user over a public network using secure sockets.

37. The method according to claim 34, further comprising sending an email to a user, wherein the email contains the portion of stored information corresponding to the openline circuit, the first end, or the second end.

38. The method according to claim 34, further comprising maintaining synchronization with the network management system.
